(19) United States
(12) Patent Application Publication
(10) Pub. No.: US 2006/0015503 A1
(43) Pub. Date: Jan. 19, 2006

(54) Location tracking of portable devices in a wireless network

(76) Inventors: Paul R. Simons, Redhill (GB); Paul A. Gough, Smallfield (GB); David E. Penna, Redhill (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/538,283

(22) PCT Filed: Nov. 21, 2003
(86) PCT No.: PCT/IB03/05347

§ 371 Date: Jun. 10, 2005

(30) Foreign Application Priority Data
Dec. 11, 2002 (GB) 0228807.4

(51) Int. Cl. G06F 17/30

(52) U.S. Cl. 707/10

(57) ABSTRACT

A method and system for anonymously and opportunistically tracking the location of a portable device in a wireless infrastructure is described. The system comprises an installed infrastructure (12) in for example a shopping mall, the infrastructure having short range radio stations (14a,14b) primarily installed as wireless information access points. Standard communication between a users device (10a) and a station (14a) is according to a short range radio protocol such as ZigBee in which devices are assigned unique identifiers. In an exchange, the identifier is correlated with location, time and date data and uploaded via a backchannel connection (16) to a database (20) which a user may connect with at a later time. The user, knowing his objects identifier, can therefore access the data to determine where his object last interacted with a station.

### FIELD OF INVENTION

The present invention relates to a method and system for opportunistically and anonymously tracking the location of a portable device.

The invention has particular application in wireless infrastructure employing wireless communication devices and protocols in which unique device identifiers are assigned to devices as part of the protocol. ZigBee™, Bluetooth™ and IEEE802.11 “WiFi”, and RFID are examples of such protocols.

### BACKGROUND TO INVENTION

One service perceived to be desired by consumers is that of object location tracking. A parent may want to track their child (perhaps surreptitiously by the placement of an object on the child!), or may want to be able to ascertain where an object they have misplaced was last located.

A method of object detection using short range radio communication is disclosed in International Patent Application WO 01/37004. This application describes a Bluetooth™ enabled luggage detection system in which a Bluetooth™ tag fitted to a user's luggage is detected by the luggage system which in turn informs a user's mobile telephone which notifies the user of the proximity of the luggage.

None of the above provide a general purpose and opportunistic tracking system and service in which a user is able to have his or her personal objects or portable devices automatically tracked, whilst maintaining their anonymity to third parties if so desired.

### OBJECT OF INVENTION

It is therefore an object of the present invention to provide a method and system for tracking the location of a user's portable device in a wireless infrastructure.

### SUMMARY OF INVENTION

According to a first aspect of the present invention there is provided a method for opportunistically tracking the location of a portable device in a wireless infrastructure comprising at least one fixed station operable to communicate wirelessly with said portable device, comprising: the portable device providing its unique identifier to the station when within communication range of said station, generating association data comprising unique identifier with the location of said station, and uploading said associated data via a back channel to a remote database wherein said data is stored.

According to a second aspect of the present invention there is provided a system for tracking the location of a portable device having the unique identifier associated therewith, comprising a wireless infrastructure having at least one fixed station, station receiving means for receiving the unique identifier transmitted by said portable device when within communication range, generation means for generating association data comprising the unique identifier with the location of said station, and uploading means for uploading said generated and associated data via a back channel to a remote database wherein said data is stored.

In a preferred embodiment of the present invention, a number of ZigBee radio stations (the stations may operate according to other short range protocols such as Bluetooth™) integrated into wireless beacons and/or access points form an infrastructure in, for example, a shopping mall. The stations are connected to an infrastructure computer, the beacons and computer thereby forming a local area network. The infrastructure computer contains information relating the stations on the network to their physical location.

A ZigBee equipped portable device (for example a mobile telephone or personal digital assistant) has a unique identifier as specified in the ZigBee standard (as does the Bluetooth radio standard). A user, transporting their portable devices (or objects containing the portable device), through the infrastructure (for example whilst shopping) will, when interacting with a station provide the unique identifier in an initial exchange as part of the standard. Since the range of beacons within said infrastructure is relatively small (generally <30 m), the device is placed at a known position and accuracy at a specific time.

It is proposed here that a station uses the identifier in the following example manner. The station, upon receiving the identifier, transmits the identifier to the infrastructure computer which receives said identifier and constructs a log comprising for example, the location data of which station has received the unique identifier and the date and time of such reception. The log can be updated when a device is first detected by a station and also when the device leaves the range of that beacon. The infrastructure computer subsequently uploads said record to a remote database. The database records a record for each unique identifier it receives, the record comprising the location date and time data submitted by the infrastructure computer.

The provision of the identifier by the portable device to the station may be achieved automatically by suitable programming of the location application running on the portable device. For example, in an initial registration enquiry, the exchange may be terminated once the portable device has provided its unique identifier to the station. Therefore, a bag or jacket pocket containing the portable device may be automatically and opportunistically detected as the the user wanders around the infrastructure. Of course, a user may override the termination if the user wishes to interact with the station in a normal fashion, that is actually use the station for it's original installed and intended purpose (for example offering information on today's special deals within the mall.) At a later time the user connects to the database via a client in the form of for example a user terminal (e.g. a home Personal Computer, Set-Top-Box and so on) and upon supply of the unique identifier, receives the record corresponding to that unique identifier.

In this fashion the user, who is the only person who knows the unique identifiers of his devices, and to which device that unique identifier relates, can view the opportunistically detected location, date and time data associated with that device. The device identifier in a ZigBee or a Bluetooth wireless device is typically a 48-bit or 64-bit unique number (a 1-20 digit number in decimal notation). It is only the user who understands the relevance of the device identifier in that it is associated with a personal possession.

The portable wireless devices may be in the form of small tags (employing for example, ZigBee, Bluetooth, WIFI IEEE802.11a/b or RF-ID hardware and protocols) and may therefore be applied to various user objects of value such as a handbag, a wallet or the user's children. Hence objects of importance may be opportunistically sensed (and therefore located at a future date) by various wireless infrastructure installed in for example a city centre, a park, an airport, car parks, shopping malls and so on.

In another embodiment the station itself may generate the record of data associating the device identifier with location, date and time and supply this directly over a back channel to the database.

The user may be charged a fee by the database provider for accessing the data on the database. In this case, the database provider may require registration of a user. However, encryption (by a web browser for example using online encryption standards) of any actual identifiers input by the user ensures anonymity since any user information relating to the user (e.g. name, address, credit card number etc) bears no relation to unique radio device identifiers unless explicitly linked.

Users who consent to location tracking and register with the database may receive free access to the database and may also control access to the database for other interested parties. In the above scenario, the infrastructure is located in a shopping mall and it is not inconceivable that retailers may be interested in the shopping patterns of visitors to the mall or within large stores. Note that the device identifiers in this case would not identify any consumer in particular but merely indicate, to a merchant of a shopping mall or store, the shopping patterns of such a person anonymously represented by the device. Perhaps a large proportion of consumers visit both shop A and shop B, or those spending time in store region A also spend time in store region B and it may be worthwhile for the owners of shop or region A and shop or region B to be aware of such a pattern.

Hence, the present invention exploits parts of a radio wireless infrastructure, perhaps installed ostensibly for other purposes, to provide simple and anonymous location tracking of objects of relevance to consumers. Of course, increasing roll-out of wireless infrastructure results ultimately in such infrastructure becoming ubiquitous, with aspects of the current invention enabling opportunistic location tracking over large areas via different protocols.

### BRIEF DESCRIPTION OF DRAWINGS

The present invention will now be described, by way of example only, and with reference to the accompanying drawings wherein;

FIG. 1 is a block diagram of a communication system.

FIG. 2 is a block diagram of a fixed station.

FIG. 3 is an infrastructure table relating stations with their respective locations.

FIG. 4 shows examples of generated associated data.

FIG. 5 shows a database storing the associated data.

It should be noted that the figures are diagrammatic and not drawn to scale. Relative dimensions and proportions of parts of these figures have been shown exaggerated or reduced in size, for the sake of clarity and convenience in the drawings, the same reference signs are generally used to refer to corresponding or similar features in modified and different embodiments.

### DETAILED DESCRIPTION

In the following we consider particularly a communication system which utilises the ZigBee low power short range protocol for communication of messages between stations. The system is also described with reference to a shopping mall scenario. As will be recognised, other radio protocol and systems may also be employed and in differing scenarios, (for example theme parks, cinemas, airports, theatres, bus and train stations, home or office networks, car parks) in which it is advantageous to offer radio services to consumers. In the following example we describe three stations forming a wireless infrastructure. It should be readily appreciated to those skilled in the art that this number is chosen simply for the sake of brevity and clarity of description, and that installed infrastructures are likely to have many tens or even hundreds of wireless stations which will enable almost seamless, short range location tracking across areas in which such infrastructures are installed.

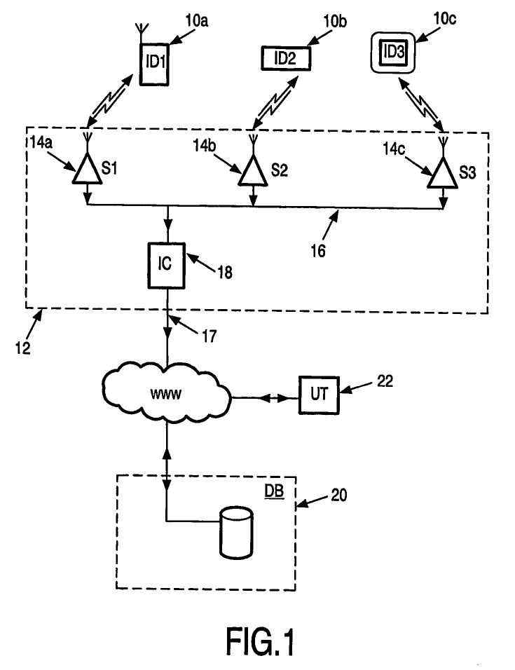

FIG. 1 illustrates a system having a wireless infrastructure 12, a client user terminal 22 (UT) such as a home Personal Computer and a database system 20. The infrastructure 12, comprises a station 14a S1, a second, fixed station 14b S2, and a third fixed station 14c S3. The stations in this embodiment are ZigBee enabled wireless access points fitted in a shopping mall. The station S3 in this embodiment represents a doorway station, at for example the entrance to a shop and installed to tempt consumers into the shop by offering consensual enticements. Stations S1 and S2 represent wireless beacons, incorporated in wireless access points located within the shopping mall and offering general information on what is available in the shopping mall and so on.

Stations S1 and S2 may have indicated interactions zones and need to be approached for interaction to begin. The stations are also connected via back channel connection means 16 to an infrastructure computer 18. The back channel means is preferably in the form of wired Ethernet cables, or may be achieved using power-line distribution methods or any other conventional wired or wireless (e.g. IEEE802.11a link to the infrastructure server computer) networking technique which allows the stations to send information to the infrastructure server 18. The plurality of stations and the connection to the infrastructure computer together form a local area network (LAN) for the infrastructure. The infrastructure computer 18 itself is connected via a conventional link 17 to the internet and from there to a remote database computer 20. The infrastructure computer stores information relating the identity of the stations in the infrastructure to their location as will be described shortly.

The stations S1, S2 and S3 are capable of radio communication with any portable devices 10a, 10b, 10c brought into range and which comply with the protocol of communication. In this example the protocol is the low power, short range (up to 50 m) standard defined by the ZigBee Alliance (www.ZigBee.com) and currently being standardised as IEEE802.15.4. The Alliance defines a simple, relatively low bit rate (250 kbits/s) and low power (or power efficient) scheme for digital radio communication using direct sequence spread spectrum techniques at 2.4 GHz. A ZigBee radio module is planned to sell in the $1-$2 range initially and therefore represents an extremely low cost and low power radio solution suitable for implementation in many devices from light switches and set-top-boxes to mobile telephones and laptops.

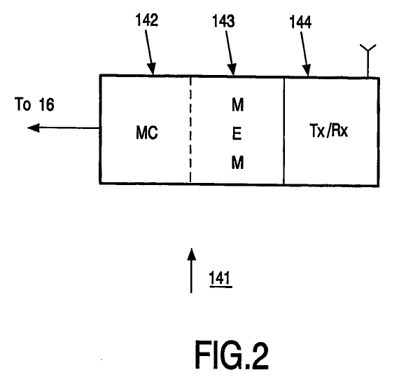

An example station 14a is shown in FIG. 2, comprising a ZigBee radio module 141 having a microcontroller 142 connected to a transceiver 144 and a memory 143. ZigBee modules in development by Applicant use a 8051 microcontroller with memory 143 in the form, of 64 kb of embedded flash memory. The memory 143 stores the ZigBee protocol and application software. For this example the application may be primarily that of a wireless information access point, therefore a standard computer (not shown) having a microprocessor and memory may be optionally connected to the ZigBee module 141. The backchannel connection 16 is via the standard computer. The computer and ZigBee module together in this embodiment perform the function of the wireless access point, but it is readily recognised by those skilled in the art that the ZigBee module 141 itself and some connection hardware for link 16 may be all that is required depending on the intended overall installation application. For the location application, application software in the module provides any detected device identifiers (as will be described in more detail below) to link 16.

Returning to FIG. 1, the diagram shows three user devices 10a, 10b, 10c, each able to communicate with stations S1, S2 and S3 respectively using the ZigBee protocol. According to ZigBee, the devices 10a, 10b, 10c each have a unique 64-bit identifier.

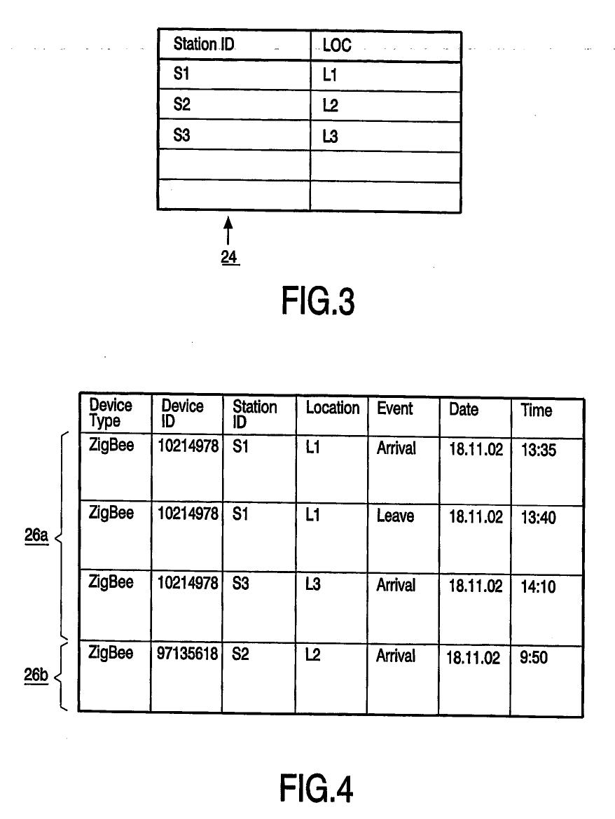

In FIG. 3 an example of a table stored by the infrastructure computer 18 is shown. The table 24, comprises station identifiers S1, S2, S3 and corresponding location data L1, L2, L3. The location data may be in any suitable form, such as a postcode or zip code, grid reference, or even street, shop name and address.

The operation of the system in this embodiment will now be described. A user device 10a begins a message transaction with a station 14a when a significant event has occurred such as the device being brought into range of the station or has left the range of the station. The transaction may be initiated or consented to by the user, or may simply be an automatic minimal response generated by application code within the user device radio module wherein detection by the portable device of a beacon signal from a station causes the portable device to transmit it's identifier to the station. Hence, the user may approach a station 14a S1 and as the user device comes into range it is automatically detected by the beacon of the infrastructure and possibly joins temporarily the local network in dependence on the application.

The station S1 therefore receives the identifier (for example the identifier 10214978 in decimal notation). Application code in the station 14a subsequently provides this identifier to the infrastructure computer 18 via the back channel communication link 16. The infrastructure computer receives the identifier, looks up in table 24 the location of the station providing the identifier, and generates data associating the identifier with the location of the station. The time and date of receipt are also preferably generated and associated with the location.

FIG. 4 shows an example of associated data generated in this embodiment by the infrastructure computer 18. The data 26a relates to the opportunistic detection of a users device having the unique identifier 10214978, the table also comprising the identifier of the station that detected the unique identifier, the location of the station (obtained for example from Table 24 stored by infrastructure computer 18 in FIG. 2), the technology type of the device, the type of event and the date and time of reception. The example data 26a illustrates that the user device having ZigBee ID 10214978 has been detected arriving at station S1, location L1 on the 18 Nov. 2002 at 13.35 and was also detected leaving station S1 at 13:40 and further detected arriving at station S3 in location L3 on 18 Nov. 2002 at 14.10.

Data 26b in FIG. 4 illustrates the associated data generated by computer 18 representing an opportunistic detection by station S2 of another device having an ID of 97135618 in location L2 on 18^{th} November 2002 at 9.50 hours.

The infrastructure computer 18 subsequently uploads the associated data to the database 20. This may be done immediately the associated data is generated, or the data may be collated by the infrastructure computer 18 on for example an hourly, or daily basis and the collated associated data uploaded overnight. The choice of how to collate and when to upload the data in this embodiment is a relatively simple consideration depending on the database and infrastructure service providers agreeing an appropriate schedule for upload.

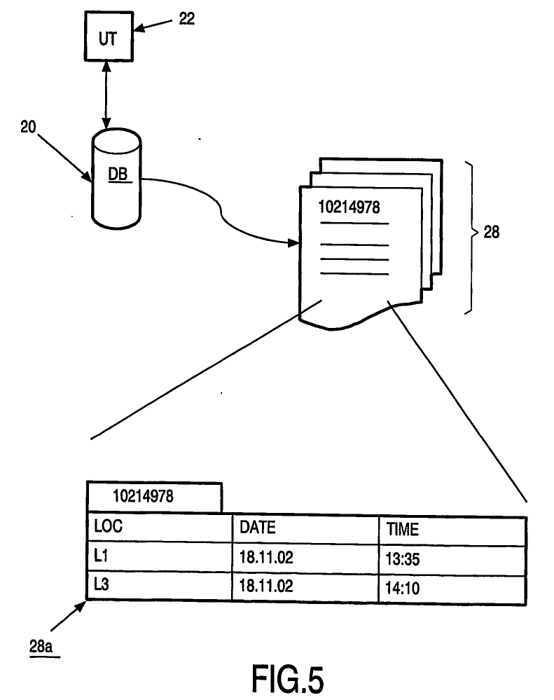

FIG. 5 represents an example database 20 and example contents 28. Upon receiving the associated data 26a, 26b the database organises the data according to device identifier. In this example Figure, the database 20 stores a stack of records 28, each record relating to a single device identifier. One of the records 28a relating to device identifier 10214978 is shown, the record storing the location, date and time data supplied by the infrastructure computer 18. The database is accessible by a client user terminal 22, which may be a home computer as stated previously, or indeed may be any user device with internet access.

The user connects to the database, using for example a standard internet connection and web browser interface, and inputs his device identifiers. Obviously, this communication should preferably be encrypted as is usual in personal transactions on the world wide web to prevent a persons device identifiers falling into the wrong hands. However, as stated previously, the device identifier in itself is just a number, and requires to be linked to a person in order for a third party to make use of any tracked location data.

Additionally, a user may register with the database providers with a simple anonymous login username and a password to also improve security. Upon connection with the database, the user inputs his known device identifiers and the database searches for any records relating to that identifier. In this example, the user owning device with identifier 10214978 would be presented with the record 28a as shown in FIG. 5.

The information in the record may be presented to the user in any suitable form commensurate with the form of location data provided by the infrastructure. For example, if the location data is in the form of Zip or Postal codes, then the data could be presented graphically in the form of a local area map. Alternatively, the location data may consist of, in the case of a shopping mall, the shopping mall name, and the shop or area in which the station is located. Hence, location L3 in FIGS. 4 and 5 may be, for example the text string “the Food Court, Crawley Mall, UK” and a user who has lost device 10214978 may receive the information in record 28a and realise that the food court was the last place the device was detected, on the 18 of Nov. 2002 at 14:10 hours.

In the above embodiment an infrastructure computer collated, generated and provided the data to the database computer.

In an alternative embodiment the stations 14a,b,c themselves store data (in memory 143) related to their current location. This information is input at initial installation and initialisation of each station. Once stored, application code causes the station 14a, when in an exchange with a device 10a, to generate associated data comprising a received unique identifier and the date and time and location of reception. The station then uploads the data to the database 20 directly via backchannel link 16.

The use of a low power radio system such as that as defined by the ZigBee alliance, (www.ZigBee.com), enables many objects to be fitted with radio communication means.

Therefore, the portable device as depicted in 10c of FIG. 1 may be in the form of a relatively low cost sticky tag incorporating a battery powered ZigBee radio module, the tag measuring roughly a few centimetres square. This embodiment of a portable device having a ZigBee module would require relatively simple application code which simply responds to any beacon signal from another ZigBee module 141 in a station 14a by supplying its identifier and then ending the exchange. Documentation sold with the tag 10c would inform the user of the unique identifier of that tag. The sticky tag could then be attached to any object of value that the user so desired, such as a handbag, a portable computer, or perhaps even their own children.

Another wireless technology, often called “RF-ID” by those skilled in the art of near field communications enables a low cost radio tag, having a unique identifier, and which is embedded in a token, key ring and the like to be used as a portable device. Hence, a portable device 10c in the form of an RF-ID tag may be employed with infrastructure according to the above embodiments to enable the provision of opportunistic location tracking services to the owner of the tag. Should a consumer lose an object containing the tag (or to which the tag is affixed) then use of the database would enable the consumer to determine where the object was last detected. In the example of a shopping mall, the consumer may then contact the mall and enquire as to whether the device was handed in.

In the foregoing, a system was described in which a user moving through a wireless infrastructure is tracked opportunistically and anonymously. Those skilled in the art of database generation and provision to users will recognise that such tracking will operate indoors as well as outdoors and furthermore is able to pinpoint the device in a range of 1-50 single metres for suitably enabled ZigBee or Bluetooth infrastructure. Additionally, the provision of information within the database to other parties may be controlled by the user using well known techniques. For example, the user may have an account with the database (anonymous or otherwise) and be declared the superuser of the account. The superuser may then grant restricted access permissions to the account to their family members or third parties and information therein then certain permissions may be granted to other parties by the user.

The above embodiments have been described in relation to a shopping mall scenario. Those skilled in the art will realise that aspects of the present invention are equally applicable to airport, train stations, theme parks, and other such public scenarios. In fact, anywhere where a ubiquitous wireless infrastructure has been deployed, ostensibly for other services.

Those skilled in the art will appreciate that the particular choice of wireless communication protocol and technology, whilst advantageous in terms of cost and power implementation for the ZigBee radio system, may also be implemented using other well known wireless communication protocols which have or provide unique identifiers to devices. Such examples at the time of making this application include the IEEE 802.11 “WIFI” standards, Bluetooth™ and RF ID tags.

In the above a method for opportunistically tracking the location of a portable device in a wireless infrastructure was described as was a system for implementing the method in which a database receives and stores the location and device identifier information. The system enables location tracking to a fine degree of accuracy (less than a metre for a walkthrough station S3) for many devices that a user owns whilst retaining anonymity. The use of unique identifiers provided in a radio communication system does not identify or reveal the person who has moved through the infrastructure, merely the device having that identifier..

From reading the present disclosure, other modifications will be apparent to persons skilled in the art. Such modifications may involve other features which are already known in the design, manufacture and use of portable radio devices having unique identifiers, radio infrastructure and component parts of wireless communication systems therein, and which may be used instead of or in addition to features already described herein without departing from the spirit and scope of the present invention.

1. A method for opportunistically tracking the location of a portable device in a wireless infrastructure comprising at least one fixed station operable to communicate wirelessly with said portable device, comprising:
the portable device providing its unique device identifier to the station when within communication range of said station,
generating association data comprising the unique identifier with the location of said station, and
uploading said associated data via a backchannel to a remote database wherein said data is stored.

2. A method according to claim 1 wherein upon receipt of a unique identifier the station transmits said identifier and its station identifier to an infrastructure computer.

3. A method according to claim 2 wherein the infrastructure computer receives said station identifier and unique device identifier, and generates association data comprising time and date of reception together with the device identifier and the location of the station.

4. A method according to claim 3 wherein the infrastructure computer uploads said associated data to the remote database.

5. A method according to claim 1 wherein the station generates association data comprising time and date of unique identifier reception together with the unique identifier and the location of the station, and the station uploads said associated data to the remote database.

6. A method according to claim 1, wherein a client terminal connects with the database, and wherein said database is operable to supply associated data to said terminal in dependence on the client supplying a unique identifier.

7. A method according to claim 6, wherein the supply of associated data is supplied in exchange for a fee.

8. A system for opportunistically tracking the location of a portable device having a unique identifier associated therewith, comprising a wireless infrastructure having at least one fixed station, station receiving means for receiving the unique identifier transmitted by said portable device when within communication range, generation means for generating association data comprising the unique identifier with the location of said station, and uploading means for uploading said generated associated data via a backchannel to a remote database wherein said data is stored.

9. A system according to claim 8, further comprising an infrastructure computer in communication with the at least one station of said infrastructure and the database, said computer having stored information relating to the location of the at least one station, and wherein said at least one station is configured to communicate the received unique identifier to the computer, and wherein said computer generates and uploads said associated data to the remote database via the backchannel.

10. A system according to claim 8, wherein communication between the at least one station and the portable device is performed via a wireless protocol in which devices are assigned unique identifiers.

11. A system according to claim 10, wherein the protocol is the ZigBee protocol.

12. A system according to claim 10, wherein the protocol is the Bluetooth protocol.

13. A system according to claim 1, further comprising a remote client terminal operable to establish a connection with the database, and wherein said database is operable to supply associated data to said client terminal in dependence on the client terminal supplying a unique device identifier.

14. A system according to claim 13, wherein the supply of associated data is supplied in exchange for a fee.

15. A database for use with the system of claim 8, said database storing location tracking information, the information comprising date, time and location data associated with a unique wireless device identifier, and wherein the database is operable to supply said information in response to a request comprising a unique device identifier.

16. A fixed station for use with the system of claim 8, comprising means for receiving a unique identifier, means for generating association data and means for uploading said data to a connected computer.

17. A portable device having a unique identifier for use with the system of claim 8 in the form of a tag having a ZigBee radio module.
